(19) United States
(12) Patent Application Publication
(10) Pub. No.: US 2002/0152948 A1
(43) Pub. Date: Oct. 24, 2002

(54) Easily carried night and day trail marker

(76) Inventor: Kenneth J. Percle, Thibodaux, LA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/838,475

(22) Filed: Apr. 18, 2001

(51) Int. Cl. G09F 3/16

(52) U.S. Cl. 116/209; 40/666

(57) ABSTRACT

A trail marking apparatus is used for marking a trail in a woodland. A spring loaded clip is normally closed under a spring tension and manually opened for attachment to a twig or small limb. The clip provides a pair of flat surfaces on opposing sides for receiving a pair of adhesive reflective markers which are engaged with the flat surfaces of the clip. A flexible streamer of approximately 10 inches in length has one end of the streamer bonded to the clip and the other end of the streamer fitted with a pair of reflective markers adhered to opposing sides of the streamer. The apparatus is used to mark a trail by engaging the clip with any natural object in the wooded area as the hunter passes. When returning at night the hunter finds the trail markers by shining a light beam in an approximate direction.

### BACKGROUND OF THE INVENTION

1. Field of the Invention

This invention relates generally to woodland marking systems and more particularly to a deer trail marking system for improving the tracking of deer and other game.

2. Description of Related Art

The following art defines the present state of this field:

Lovelace, U.S. D357,428 provides an ornamental design for the reflective trail marker.

Ryder, U.S. Pat. No. 3,685,482 describes a trail marker formed of readily foldable material having a tie portion reinforced by a length of flexible wire, and a connected tail portion. The reinforced tie portion is constructed so that the opposed ends thereof can be readily wrapped and secured about a tree branch or the like to mark a trail.

Flowerday, U.S. Pat. No. 3,785,337 describes a warning device for use on fence wire, trees, posts and the like. The device has a flat base and an integral strap extending from an edge thereof. The free end of the strap has fastening means on the end thereof adapted to be coupled with the base of the device or the base of an adjacent warning device. The strap can encircle a fence wire or it can be secured, as by nails, to trees and posts for marking trails, driveway entrances and the like. A light reflector is mounted on the base.

Britt et al., U.S. Pat. No. 4,401,050 describes a phosphorescent escape route indicator having at least one protruding indicia formed within or attached to a sheet of material. The protruding indicia has incorporated therewith a phosphorescent substance capable of emitting a glow in the absence of light. An adhesive formed as part of the sheet is utilized to apply the indicator to the surface of walls or stairways thereby aiding in delineating escape routes or access routes to emergency equipment during time of emergency.

Berlet, U.S. Pat. No. 4,145,793 describes a clothespin with two elongated members each having a forward end defining a gripping portion and a centrally disposed pivot portion about which each elongated member pivots. A spring acts to bias the gripping portions into abutment with each other and to hold the elongated members together. To further restrain the sliding of one elongated member with respect to the other, a key and groove locking mechanism is provided forward of the pivot portion, whereby the locking mechanism will operate with a minimum of wear due to pivoting forces generated in the operation of the clothespin.

Gibson, U.S. Pat. No. 5,000,111 describes a trail marking device for marking a trail and guide an individual who is retracing his steps in a wooded area during daylight or darkness. The trail marking device includes an elongate sheet of light reflecting material which can be easily seen in the daylight and an abutting strip of luminescent material which can be more easily viewed in darkness. A plurality of longitudinally spaced, longitudinally aligned wire sections are sandwiched between the strips for securing individual sheet sections to a tree limb. The sheet sections are detachably coupled to adjacent sheet sections along perforated break lines. The strips are wound on a spool which include a plurality of tacks which can be used for alternately tacking the strips to a tree.

The prior art teaches the use of markers and marking systems for woodland trails but does not teach a system that is useful at night for guiding hunters into and out of a wooded area. The present invention fulfills these needs and provides further related advantages as described in the following summary.

### SUMMARY OF THE INVENTION

The present invention teaches certain benefits in construction and use which give rise to the objectives described below.

A trail marking apparatus is used for marking a trail in a woodland. A spring loaded clip is normally closed under a spring tension and manually opened for attachment to a twig or small limb. The clip provides a pair of flat surfaces on opposing sides for receiving a pair of adhesive reflective markers which are engaged with the flat surfaces of the clip. A flexible streamer of approximately 10 inches in length has one end of the streamer bonded to the clip and the other end of the streamer fitted with a pair of reflective markers adhered to opposing sides of the streamer. The apparatus is used to mark a trail by engaging the clip with any natural object in the wooded area as the hunter passes. When returning at night the hunter finds the apparatus by shining a light beam in its direction.

A primary objective of the present invention is to provide an apparatus and method of use of such apparatus that provides advantages not taught by the prior art.

Another objective is to provide such an invention capable of marking a trail to be seen at night.

A further objective is to provide such an invention capable of being easily carried about a persons neck.

A still further objective is to provide such an invention capable of being easily attached to natural object as a person moves through a wooded area.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a left side elevation view of the preferred embodiment of the invention;

FIG. 2 is a right side elevation view thereof.

FIG. 3 is a close-up plan view thereof;

FIG. 4 is top plan view thereof;

FIG. 5 is a bottom plan view thereof, and

FIG. 6 is a perspective view thereof.

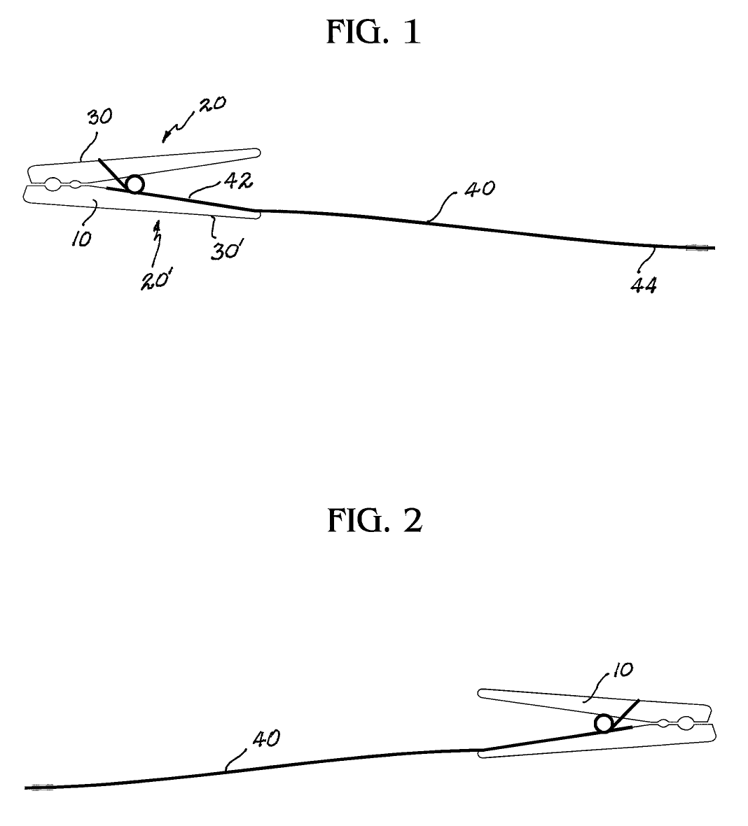

### DETAILED DESCRIPTION OF THE INVENTION

The above described drawing figures illustrate the invention in at least one of its preferred embodiments, which is further defined in detail in the following description.

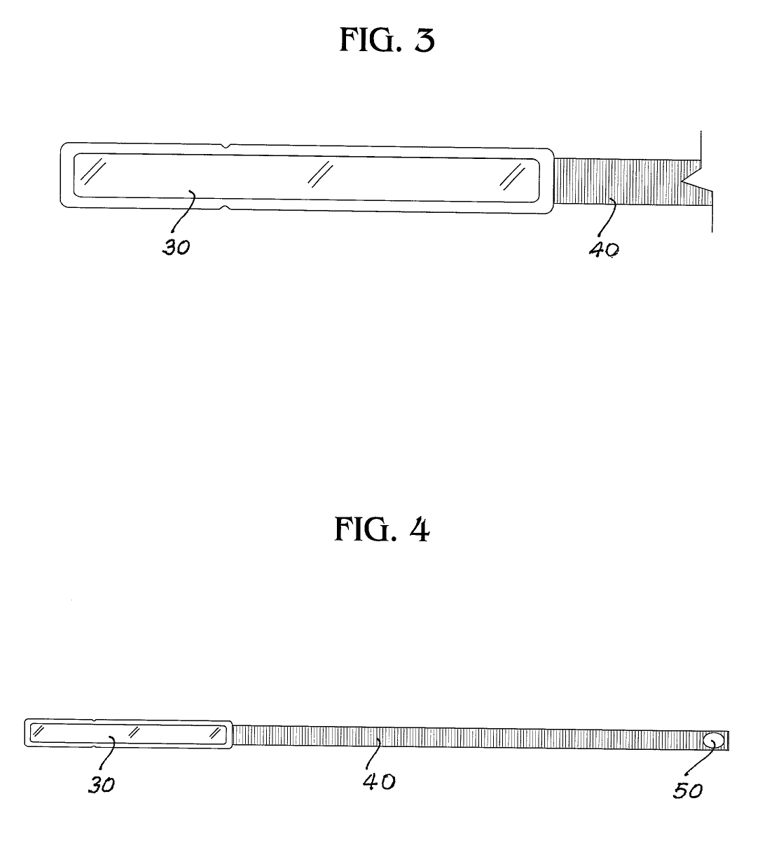

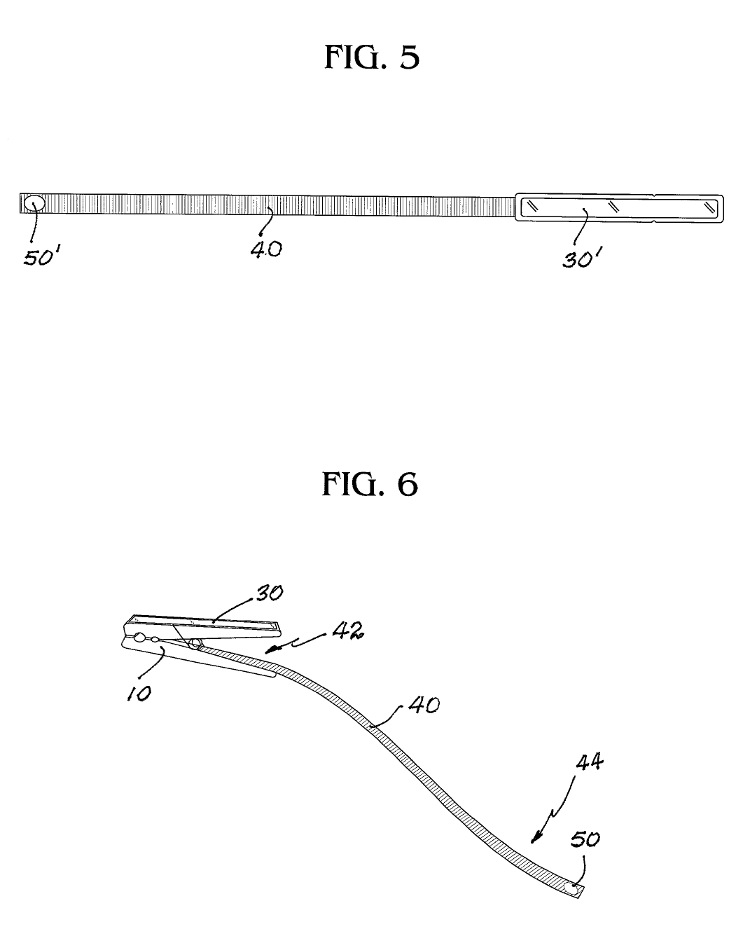

The present invention is a trail marking apparatus for marking a trail in a woodland. It comprises a spring loaded clip 10 adapted as normally closed under a spring tension, such as a clothespin type, and manually opened for attachment to a twig or small limb of a tree, or any other natural object in a hunter's trail. The clip 10 provides a pair of flat surfaces 20, 20′ on opposing sides thereof. A pair of first adhesive reflective markers 30, 30′ are adhesively engaged with the flat surfaces 20, 20′ respectively, of the clip 10, as shown in FIGS. 3-5. A flexible streamer 40 made of cloth or plastic is approximately 10 inches in length. The fact that the streamer is flexible enables it to move with the wind so as to be better seen. One end 42 of the streamer 40 is bonded, or otherwise joined to the clip 10 and the other end 44 of the streamer 40 provides a pair of second reflective markers 50, 50′ adhered to opposing sides of the streamer 40. The materials of construction are well known to the craftsman in this field, and the reflective materials are also well known. The reflective markers 50, 50′ are preferably made to reflect light at night in the same manner as for roadside markers and emergency patches and the like. The materials of construction are also preferably of a bright color such as orange so as to be visible during daylight hours.

In operation, the above described apparatus is first placed for encircling the neck of a hunter such that the other end 44 of the flexible streamer 40 is engaged with the clip 10 to form a closed loop. When the hunter is moving on a trail in a wooded area the hunter disengages the flexible streamer 40 from the clip 10 to remove the apparatus from around the hunter's neck, and this may be accomplished while the hunter is moving rapidly over terrain since the loop is so close at hand, i.e. encircling his/her neck. The apparatus is thus drawn away from the hunter and engaged with a flora to mark a trail as the hunter passes the flora. Upon returning, as in finding his/her way out of the wooded area, the hunter takes the step of shining a light in the direction of the apparatus to find the trail. Clearly, the hunter would carry a supply of the apparatus around the neck so as to be able to amply mark the trail.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A trail marking apparatus for marking a trail in a woodland which comprises: a spring loaded clip adapted as normally closed under a spring tension and manually opened for attachment to a twig or small limb, the clip providing a pair of flat surfaces on opposing sides thereof, a pair of first adhesive reflective markers are adhesively engaged with the flat surfaces of the clip; a flexible streamer of approximately 10 inches in length, one end of the streamer being bonded to the clip and the other end of the streamer providing a pair of second adhesive reflective markers adhered to opposing sides of the streamer.

2. The apparatus of claim 1 wherein at least one of the clip, first adhesive reflective markers, streamer, and second adhesive reflective markers are of a bright color.

3. A method of using a trail marking apparatus comprising: providing a spring loaded clip adapted as normally closed under a spring tension and manually opened for attachment to a twig or small limb, the clip providing a pair of flat surfaces on opposing sides thereof; a pair of first adhesive reflective markers adhesively engaged with the flat surfaces of the clip; a flexible streamer of approximately 10 inches in length, one end of the streamer being bonded to the clip and the other end of the streamer providing a pair of second reflective markers adhered to opposing sides of the streamer; encircling the neck of a hunter with apparatus such that the other end of the flexible streamer is engaged with the clip to form a closed loop, disengaging the flexible streamer from the clip to remove the apparatus from around the neck of the hunter; and engaging the clip to a flora to mark a trail.

4. The method of claim 2 further comprising the step of shining a light on the apparatus to find the trail.
